(19) United States
(12) Patent Application Publication
(10) Pub. No.: US 2012/0161636 A1
(43) Pub. Date: Jun. 28, 2012

(54) OCCUPANCY SENSOR FOR TASK LIGHTING APPLICATION

(75) Inventors: MOHAMED ASLAM KHAZI, BLOOMFIELD HILLS, MI (US); KENNETH WALTER CZECH, DARTMOUTH, MA (US)

(73) Assignee: KONINKLIJKE PHILIPS ELECTRONICS N.V., EINDHOVEN (NL)

(21) Appl. No.: 12/979,689

(22) Filed: Dec. 28, 2010

(51) Int. Cl. H05B 37/02

(52) U.S. Cl. 315/121

(57) ABSTRACT

A method for saving energy in locations using a plurality of luminaires situated in close proximity to each other, the method including providing each luminaire with a sensor for detecting presence of a person in proximity to the luminaire, a component for enabling passage of current through to the luminaire when the presence is detected and disabling the passage of the current through to the luminaire after a predetermined timeout, and a switch coupled between the component and the luminaire for enabling powering of the luminaire ON, wherein passage of power to each luminaire is enabled by the component when the presence is detected and the luminaire is powered ON by the switch.

The present system relates to energy conservation through the use of lighting control technology and more particularly to limiting the usage of lighting when and where needed.

In work or living situation where abundant task lights are utilized, for example, lab benches in laboratories and schools, dining tables in restaurants, reading tables in libraries, room lighting, such as within a home, etc., controlling the task lights with occupancy sensors in a manner currently known does not solve the problem of conserving energy while providing sufficient lighting. A central occupancy sensor can be used to centrally control a plurality of task lights to conserve the energy, yet all the lab benches with task lights may not be occupied. If just one task light needs to be, then all the task lights must be turned on. A similar problem arises when lights are controlled by local sensors that are attached to all the task lights. That is because motion of a person towards only one light will be detected by the sensors of all the surrounding task lights.

What is needed is a system of luminaire control that can conserve energy beyond simple group control.

It is an object of the present system to overcome disadvantages and/or make improvements in the prior art.

It is another object of the present system to assure energy saving in areas having many task lights situated in proximity to each other.

Accordingly, the present system includes an apparatus having a luminaire; a sensor for detecting presence of a person in proximity to the luminaire, such as in close proximity to the luminaire (e.g., next to the luminaire); a component for enabling passage of current through to the luminaire when the presence is detected and disabling the passage of the current through to the luminaire after a predetermined timeout; and a switch coupled between the component and the luminaire for enabling powering of the luminaire ON.

Further provided is a method for saving energy in locations using a plurality of luminaires situated in proximity to each other, the method including providing each luminaire with a sensor for detecting presence of a person in a proximity to the luminaire, a component for enabling passage of current through to the luminaire when the presence is detected and disabling the passage of the current through to the luminaire after a predetermined timeout, and a switch coupled between the component and the luminaire for enabling powering of the luminaire ON, wherein passage of power to each luminaire is enabled by the component when the presence is detected and the luminaire is powered ON by the switch.

The present system is explained in further detail, and by way of example, with reference to the accompanying drawings wherein:

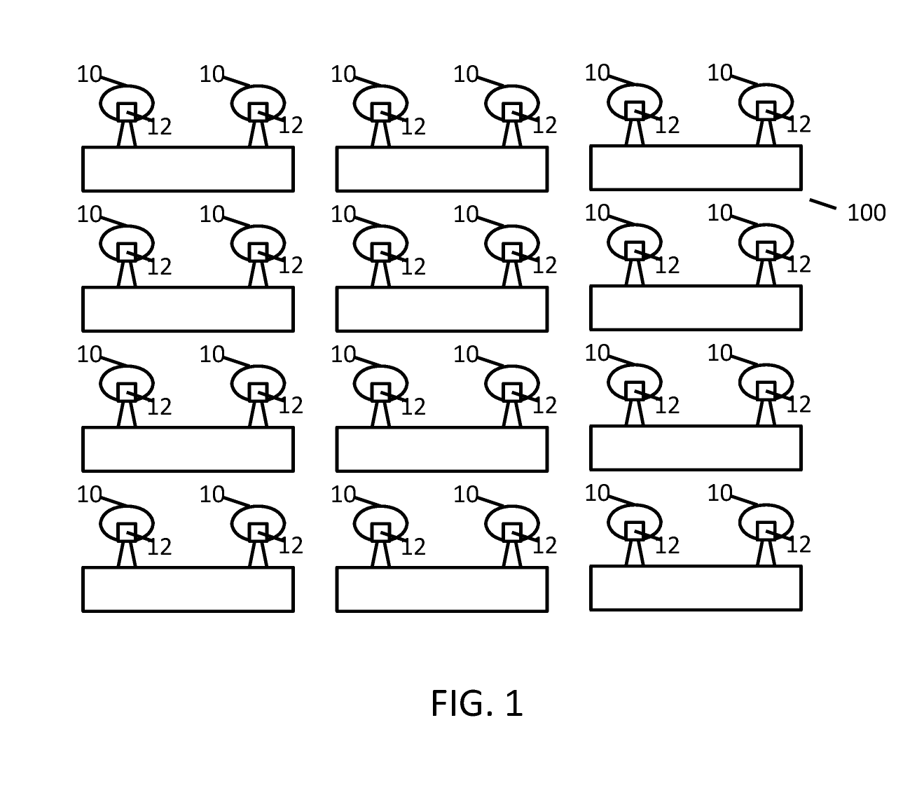

FIG. 1 shows a diagram of an exemplary location where a plurality of luminaires are situated in proximity to each other in accordance with embodiments of the present system; and

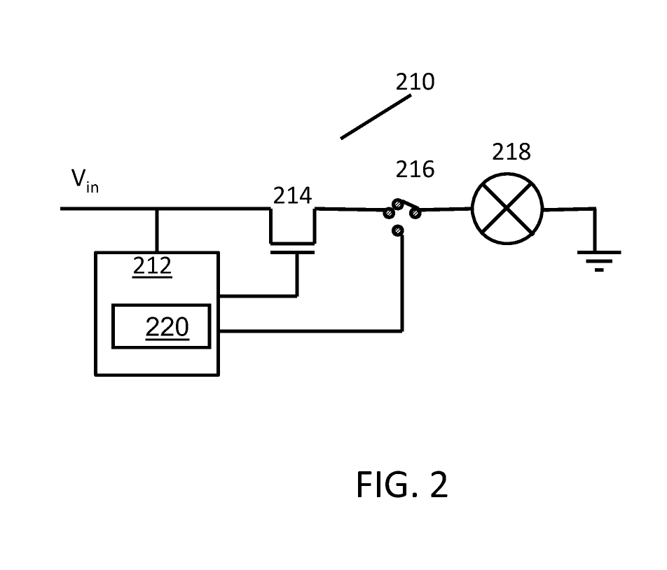

FIG. 2 shows a diagram of an exemplary embodiment of an occupancy sensor in one of a plurality of luminaires situated in proximity to each other in accordance with embodiments of the present system.

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well known devices, circuits, tools, techniques and methods are omitted so as not to obscure the description of the present system. It should be expressly understood that the drawings are included for illustrative purposes and do not represent the scope of the present system. In the accompanying drawings, like reference numbers in different drawings may designate similar elements.

For purposes of simplifying a description of the present system, the terms “operatively coupled”, “coupled” and formatives thereof as utilized herein refer to a connection between devices and/or portions thereof that enables operation in accordance with the present system. For example, an operative coupling may include one or more of a wired connection and/or a wireless connection between two or more devices that enables a one and/or two-way communication path between the devices and/or portions thereof.

FIG. 1 is a diagram 100 of an exemplary establishment where a plurality of luminaires 10 is situated close to each other in accordance with embodiments of the present system. The present system and method are directed to limiting the usage of task lighting when and where needed. FIG. 1 illustrates a situation where the plurality of luminaires 10 may be used, such as for example, at laboratory benches, dining tables in restaurants, reading tables in libraries, room lighting, kitchen lighting, etc., yet all the luminaires 10 may not need to be lit at the same time. As addressed by the embodiments of the present system, solely controlling the lights from a central occupancy sensor does not help in conserving energy when not all the potentially lit areas are occupied or are otherwise needed to be lit at the same time. In accordance with embodiments of the present system, an individual occupancy sensor 12 is integrated into each luminaire 10 so that logic that is programmed on the individual occupancy sensor 12 will help control corresponding luminaires 10 without causing adjacent luminaires 10 to become lit. In accordance with embodiments of the present system, the individual occupancy sensor 12 may detect a presence of a person with regard to a given luminaire 10. In accordance with embodiments of the present system, the individual occupancy sensor 12 may detect close presence of the person with regard to the luminaire, such as within one (1) foot, two (2) feet, etc., of the luminaire 10.

FIG. 2 shows a diagram of an exemplary embodiment of an occupancy sensor 212 in one of a plurality of luminaires 210 situated in proximity to each other in accordance with embodiments of the present system. To simplify the following discussion, one of the plurality of luminaires 210 is discussed. It would be readily appreciated by a person of ordinary skill in the art, that the luminaire 210 may be representative of the plurality of luminaires 10 shown in FIG. 1.

In FIG. 2, the luminaire 210 is shown comprising a light source 218, such as an one or more incandescent bulbs, light emitting diodes (LEDs), high intensity discharge (HID) lamps, etc., coupled to a power source Vin through a component 214 and a switch 216.

In accordance with embodiments of the present system, the switch 216 may be a manually operated switch (e.g., toggle switch, depression switch, etc.) for turning on the light source 218 only when it is needed as opposed to prior systems which turn on all of the plurality of connected light sources in response to a detected presence. By not turning on lights even when user presence in an area (e.g., a room) is detected, considerable energy may be saved. In accordance with embodiments of the present system, the sensor 212, the component 214 and the switch 216 may be built into the luminaire 210, such as seamlessly integrated into the luminaire 210. Further, the power supply Vin providing power to the light source 218 may also provide power to the sensor 212 or a separate power supply may be provided to the sensor 212. The sensor 212 is shown operatively coupled to the component 214 and the switch 216 for controlling the component 214 and the switch 216. In accordance with embodiments of the present system, the sensor 212 is a presence detector which detects presence of a person in a vicinity of the luminaire 210. For example, the sensor 212 may detect motion of the person, may detect heat radiated from the person (e.g., such as an infrared, IR sensor), may detect a change in air pressure caused by the person when the person is moving, etc. As readily appreciated, numerous other systems for detecting the presence of the person may be suitably employed for the sensor 212.

In operation, when the sensor 212 detects the presence of the person, the sensor 212 controls the component 214 (e.g., a transistor, relay, etc.) to enable power to flow from the power source Vin (e.g., the component 214 is turned ON) through to the switch 216, e.g., a manually actuated switch. When the switch 216 is turned on after the sensing condition such as by the person toggling a toggle switch and/or depressing a pushbutton switch, like a single pole single throw (SPST) switch as the switch 216, the light source 218 is energized, i.e., the luminaire 210 is ON (e.g., lit). In embodiments of the present system wherein the sensor 212 includes a timer 220, a predetermined time (e.g., 5 minutes, 10 minutes, 15 minutes etc.) after the presence of the person is no longer detected, a programmable timer 220 within the sensor 212, will turn OFF the luminaire 210. For example, after the predetermined time, the sensor 212 may control the component 214 to turn OFF (e.g., cause the component 214 to not transmit the Vin to the switch 216), which turns OFF the light source 218 and thereby, turns OFF the luminaire 210.

In accordance with embodiments of the present system, the turning OFF of the luminaire 210 is performed without a determination of the present state of the switch 216. Further, the state of the switch 216 may be reset by the sensor 212 before the next use. In accordance with embodiments of the present system, the state of the switch 216 is reset when the sensor 212 turns OFF the component 214 (e.g., the component 214 is turned OFF at the same time as the switch 216).

In an alternative embodiment, the sensor 212 resets the switch 216 only if the state of the component 214 is already previously OFF (e.g., such as a predetermined time thereafter) to avoid the luminaire 210 staying OFF when the person has only temporally left an area of the luminaire 210 and returns before the predetermined time. For example, a user may switch on the luminaire using a push button switch 216. Since the sensor 212 (e.g., occupancy sensor for a task light, such as in a laboratory environment) constantly senses motion while the user is present (e.g., in proximity to the luminaire 210), power is maintained to the light source 218 (e.g., the light source 218 is ON), for example through the component 214 and the switch 216. After a time, the user may leave the area of the luminaire 210. In accordance with embodiments of the present system, after there is no motion detected for a first predetermined amount of time (e.g., a default time and/or user/operator settable, such as a time of 5-20 minutes, such as 15 minutes), the sensor 212 cuts the power to the light source 218, such as a light emitting diode printed circuit board (LED PCB) source. For example, the sensor 212 may shut OFF the component 214 but not reset the switch 216, at least for some further time. In this way, when there is a motion detected within a second predetermined amount of time that is longer than the first predetermined amount of time (e.g., 45 minutes (t2>t1)), the sensor 212 can turn ON the component 214, thereby powering ON the LED PCB automatically (e.g., without the user having to turn ON (again) the switch 216. In a case wherein there is no motion detected after a third predetermined amount of time greater than the first and second predetermined amount of time (e.g., 60 minutes, t3>t2>t1), the sensor 212 may reset the switch 216, thereby requiring the user to manually activate the switch 216 (e.g., depress a push button switch) to turn ON the luminaire 210 after the user returns to the proximity of the luminaire 210. In embodiments of the present system, one or more of the sensor 212 and the component 214 may be a portion of a central occupancy sensor that controls all of a plurality of luminaires within an area while each one of a plurality of switches 216 are dedicated (e.g., formed as a part of the luminaire) to corresponding ones of the plurality of luminaires.

In embodiments of the present system, one or more of the component and the switch may form a portion of the sensor. In embodiments of the present system, one or more of the sensor 212, timer 220, component 214 and switch 216 may form a part of a processor (e.g., operationally coupled to a memory), logic device(s), controller(s), application specific integrated circuit(s) (ASICs), Solid State Logic (SSL), logic arrays, shifters, etc., which when suitably programmed, configured, etc., may be configured to implement the methods, operational acts, and functions disclosed herein. In the case of a processor, the application data and other data are received by the processor for configuring (e.g., programming) the processor to perform operation acts in accordance with the present system. The processor so configured becomes a special purpose machine particularly suited for performing in accordance with the present system.

The following state diagram illustrates a functioning of the embodiments of FIG. 2 in accordance with embodiments of the present system.

| Sensor 212 | Component 214 | Switch 216 | Luminaire 210 |
|---|---|---|---|
| Presence Detected | ON | ON | ON |
| | | (manually actuated) | |
| | ON | OFF | OFF |
| Timeout (no | OFF | ON | OFF |
| presence detected) | OFF | OFF | OFF |

As discussed, switch 216 may be reset to the OFF state after Timeout is determined (e.g., immediately or after the predetermined time, such as after t3).

Another feature in accordance with embodiments of the present system lies in the programmed logic (e.g., Solid State Logic (SSL)) may be utilized for and/or may replace one or more of the sensor 212, the component 214, the switch 216 and/or the timer 220. The logic is programmable for various specific applications to enhance power savings. For example, timing requirements and timers may be programmed/performed using timer integrated circuits (ICs), such as SSL ICs. In these embodiments of the present system, the timer ICs may actuate the component 214 (e.g., a relay switch) based on the signal from the sensor mounted on a luminaire assembly.

In embodiments of the present system in accordance with FIG. 2, the switch 216 may actuate (e.g., enable the sensor to sense presence/proximity of the user) the sensor 212. In these embodiments, the sensor 212 is disabled if the switch 216 is OFF and/or is switched OFF. In operation of these embodiments, the user at some time switches ON the switch 216 (e.g., by depressing a single pole single throw normally open (SPST N.O.) push button switch corresponding to the switch 216). Switching ON the switch 216 enables the sensor 212 which maintains the luminaire 210 ON as long as the users presence is sensed. In these embodiments, after the user is no longer sensed in proximity to the luminaire (e.g., immediately or some time thereafter, such as after t3 as discussed herein), the sensor 212 may turn OFF the luminaire. In further embodiments of the present system, the switch 216 may turn ON the light source 218 directly while also enabling the sensor 212. In this way and in accordance with other embodiments discussed herein, at any time the user may manually switch ON or OFF the luminaire by actuating the switch 216 (e.g., push a pushbutton switch to turn luminaire ON, push the pushbutton switch again to turn luminaire OFF).

Finally, the above discussion is intended to be merely illustrative of the present system and should not be construed as limiting the appended claims to any particular embodiment or group of embodiments. Thus, while the present system has been described with reference to exemplary embodiments, including devices, it should also be appreciated that numerous modifications and alternative embodiments may be devised by those having ordinary skill in the art without departing from the broader and intended spirit and scope of the present system as set forth in the claims that follow. Further, while exemplary user interfaces are provided to facilitate an understanding of the present system, other user interfaces, devices, systems, etc., may be provided and/or may be combined together in accordance with further embodiments of the present system.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices, portions thereof, acts, etc., may be combined together or separated into further portions, acts, etc., unless specifically stated otherwise;

h) no specific sequence of acts or steps is intended to be required including an order of acts or steps indicated within a flow diagram; and

i) the term “plurality of” an element includes two or more of the claimed element, and does not imply any particular range of number of elements; that is, a plurality of elements may be as few as two elements, and may include an immeasurable number of elements.

What is claimed is:

1. An apparatus comprising:
a luminaire;
a sensor for detecting presence of a person in proximity to the luminaire;
a component for enabling passage of a supply voltage through to the luminaire when the presence is detected and disabling the passage of the supply voltage through to the luminaire after the presence is no longer detected; and
a switch coupled between the component and the luminaire for enabling powering of the luminaire ON.

2. The apparatus of claim 1, further comprising a plurality of luminaires situated in close proximity to each other and each including the switch.

3. The apparatus of claim 2, wherein a designated luminaire of the plurality of luminaires is enabled by the component and powered ON by a corresponding switch, thereby limiting usage of power.

4. The apparatus of claim 1, wherein the sensor is powered from a same source as the luminaire.

5. The apparatus of claim 1, further comprising a timer within the sensor and a processor for programming the timer for disabling the luminaire after a preprogrammed time.

6. The apparatus of claim 5, wherein the switch includes a status selected from ON and OFF and the status is reset to OFF when the luminaire is disabled by the timer or manually by the user.

7. The apparatus of claim 6, wherein the switch is manually switchable to OFF by a user to turn OFF the luminaire.

8. A method for saving energy in locations using a plurality of luminaires situated in proximity to each other, the method comprising acts of:
providing each luminaire with a sensor for detecting presence of a person in proximity to the luminaire, a component for enabling passage of current through to the luminaire when the presence is detected and disabling the passage of the current through to the luminaire after a predetermined timeout, and a switch coupled between the component and the luminaire for enabling powering of the luminaire ON,
wherein passage of power to each luminaire is enabled by the component when the presence is detected and the luminaire is powered ON by the switch.

9. The method of claim 8, wherein the sensor and the luminaire are powered from a same source.

10. The method of claim 8, further comprising acts of:
providing the sensor with a timer and a processor for programming the timer; and
disabling the luminaire after a preprogrammed time.

11. The method of claim 10, further comprising an act of selecting a status of the switch from ON and OFF and resetting the status to OFF when the luminaire is disabled by the timer.

12. The method of claim 10, further comprising an act of manually switching the switch to OFF to turn OFF the luminaire.
